(19) United States
(12) Patent Application Publication
(10) Pub. No.: US 2023/0157477 A1
(43) Pub. Date: May 25, 2023

(54) Method of Making a Tea Beverage

(71) Applicant: BONSAI CHA INC., East Selkirk (CA)

(72) Inventors: Avery Daune Hastings, East Selkirk (CA); Donna Lee Hastings, East Selkirk (CA)

(21) Appl. No.: 17/969,336

(22) Filed: Oct. 19, 2022

(30) Foreign Application Priority Data
Nov. 21, 2021 (CA) 3139366

(51) Int. Cl. A47J 31/18

(52) U.S. Cl. CPC A47J 31/18

(57) ABSTRACT

A method of making a tea beverage includes adding a liquid and a tea powder to the vessel of a mixing device. The mixing device includes (i) a rotatable mixing member for mixing the liquid and the tea powder to make a tea mixture and (ii) a heating element for heating the tea mixture up to a desirable serving temperature. mixing member and the heating element can be actuated together to simultaneously heat and mix the tea mixture. The mixing member is a whisking type mixer for frothing the tea mixture as the tea powder is mixed with the liquid and as the tea mixture is heated.

This application claims foreign priority benefits from Canadian Patent Application 3,139,366 filed Nov. 17, 2021.

### FIELD OF THE INVENTION

The present invention relates to a method for preparing matcha or other tea beverages by mixing a tea powder with a liquid.

### BACKGROUND

Matcha is a powdered green tea derived from the tea plant Camellia sinesis. The tea powder is produced from tea leaves which are shade-grown for several weeks. The tea leaves are steamed, cooled and dried, then de-stemmed and de-veined to create what is called “tencha”. The tencha leaves are then ground into a fine powder which becomes matcha. Traditionally, matcha powder is consumed as a hot tea by whisking the powder with hot water using a bamboo whisk in a bowl (chasen). Manually preparing and whisking the mixture is time-consuming, requires precision and can yield varying results. There is a need to provide improvements over manual preparation by providing ease of preparation and enhanced precision through automation.

### SUMMARY OF THE INVENTION

The invention provides a method to make a tea beverage using a tea powder.

According to one aspect of the invention, the present invention relates to a method of making a tea beverage using a tea powder, the method comprising:

providing a mixing device including a vessel for containing a liquid therein, a mixing member supported within the vessel for rotation relative to the vessel, and a heating element operatively connected to the vessel so as to be arranged to heat contents of the vessel;

partly filling the vessel of the mixing device with a selected liquid;

adding a prescribed amount of the tea powder to the selected liquid in the vessel;

actuating the mixing member and the heating element of the mixing device so as to simultaneously (i) mix the selected liquid and the tea powder to form a mixture and (ii) heat the mixture.

The method of preparation comprises partly filling the vessel of the mixing device with a selected liquid;

adding a prescribed amount of the tea powder to the selected liquid in the vessel; and

actuating the mixing member and the heating element of the mixing device to simultaneously (i) mix the selected liquid and the tea powder to form a mixture and (ii) heat the mixture.

Use of a motor driven mixing member while simultaneously heating the mixture has been found to create a desirable frothing of the tea mixture that can be reproduced more consistently and with much less effort as compared to traditional manual whisking of the tea powder with hot water.

The method may further comprise (i) partly filling the vessel of the mixing device with approximately 100 to 250 millilitres of the selected liquid, (ii) adding the prescribed amount of tea powder in the range of approximately 1 to 20 grams, and/or (iii) mixing and heating the mixture for a duration in the range of 1 to 2 minutes and more preferably for approximately 90 seconds. For example, preparing 20 grams of tea powder with 250 millilitres of fluid would constitute “koicha” or “thick tea” in traditional preparation.

The method may further include heating the mixture to a temperature exceeding 60 degrees Celsius, and more preferably to a temperature of approximately 65 degrees Celsius, while mixing the mixture.

The mixture is preferably dispensed from the mixing device to a serving cup subsequent to heating and mixing the mixture.

When the mixing member comprises an agitator, the method may further comprise frothing the mixture using the agitator. Preferably the agitator comprises a plurality of windings of elongated strand material forming a coil.

When the mixing device further includes a common actuator button, the method may further include actuating the mixing of the mixture with the mixing member and actuating the heating of the mixture with the heating element simultaneously using the common actuator button.

The method may further include providing a timer on the mixing device and actuating the mixing member and the heating element for prescribed duration determined by the timer.

According to an alternative mode of operation, when the mixing device again includes a common actuator button on the mixing device, the method may alternatively include actuating the mixing of the mixture with the mixing member but not actuating the heating of the mixture with the heating element in response to the common actuator button being depressed twice in succession within a prescribed duration.

### BRIEF DESCRIPTION OF THE DRAWINGS

One embodiment of the invention will now be described in conjunction with the accompanying drawings in which:

FIG. 1 is a perspective view of a mixing device for mixing the tea beverage;

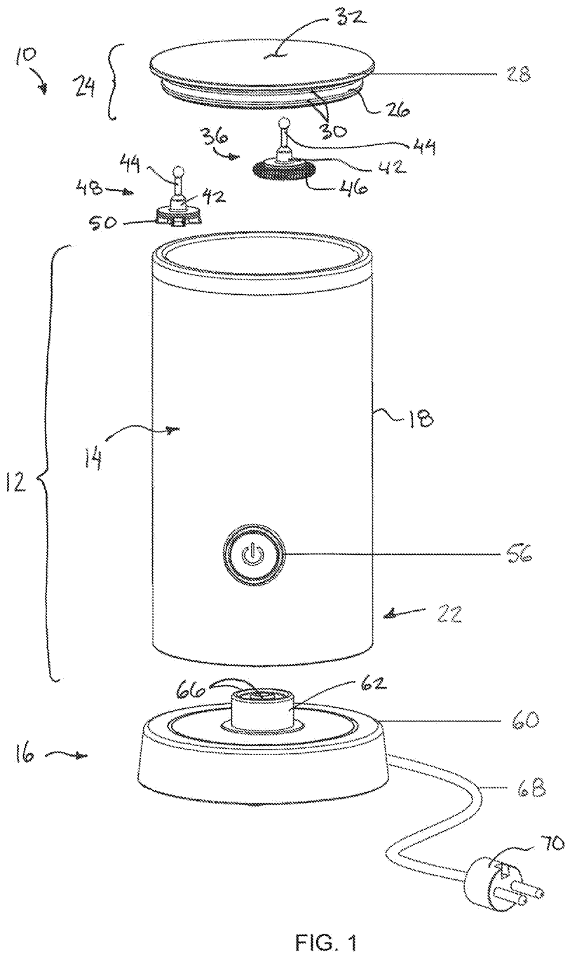

FIG. 2 is a schematic representation of the mixing device; and

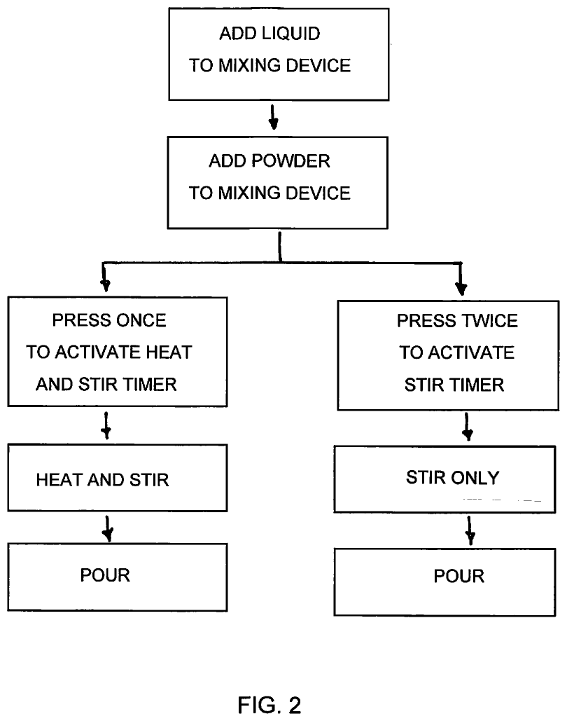

FIG. 3 is a flow chart illustrating a method of forming a tea beverage using the mixing device.

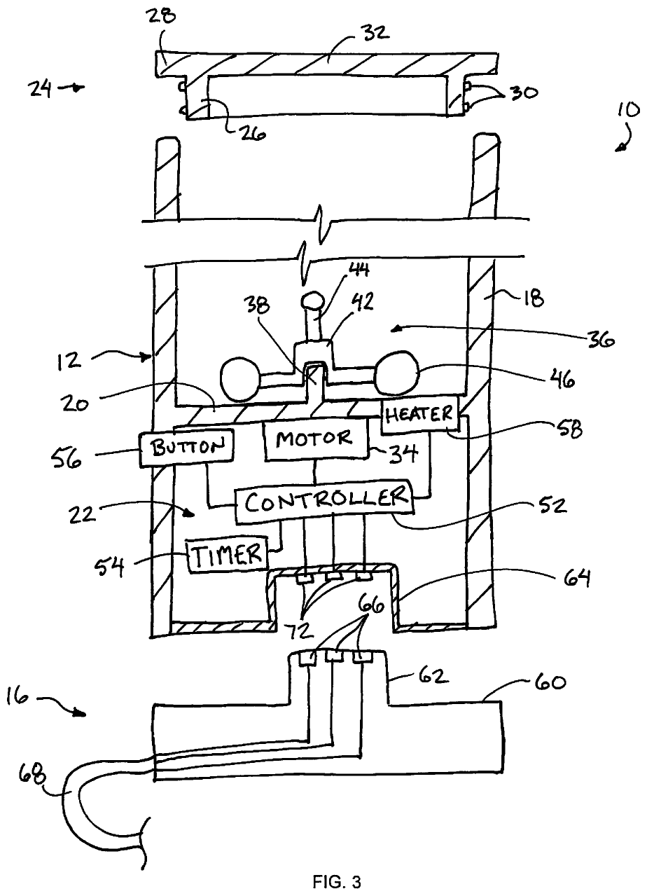

In the drawings, like characters of reference indicate corresponding parts in the different figures.

### DETAILED DESCRIPTION

Referring to the accompanying figures, there is illustrated a tea beverage mixing device generally indicated by reference numeral 10, for use in preparing a tea mixture, and more particularly for preparing a matcha beverage formed from a liquid, such as water or milk, mixed with a matcha tea powder.

The mixing device 10 includes (i) a main housing 12 defining a vessel arranged to contain a liquid therein and (ii) a base 16 arranged for connection to a power supply and for supporting the main housing 12 thereon to deliver the electrical power from the power supply to the main housing.

The main housing 12 includes a cylindrical perimeter wall 18 incorporating a layer of heat insulating material therein to define the perimeter boundary of the vessel 14 within the main housing. A bottom wall 20 spans across the cylindrical wall in proximity to the bottom end of the main housing to define a lower boundary of the vessel 14. A remaining portion of the cylindrical wall 18 extending below the bottom wall 20 defines a lower chamber 22 therein which receives various operating components of the mixing device as described below. The cylindrical wall 18 remains open at the top end thereof for accessing the interior of the vessel 14 through the open top end of the housing.

A lid 24 is provided for selectively enclosing the open top end of the vessel of the main housing. More particularly, the lid includes a lower portion 26 formed of a cylindrical wall having an outer diameter that fits closely within the inner diameter of the perimeter wall 18 of the vessel. The lid further includes a rim 28 protruding radially outward from the top of the lower portion 26 by a distance corresponding to a wall thickness of the cylindrical wall 18 of the main housing such that the outer edge of the rim 28 is substantially flush with the exterior surface of the cylindrical wall of the main housing when the lid is partly received into the open top end of the main housing. One or annular sealing rings 30 are supported at spaced locations to extend about the lower portion 26 of the lid to secure the lid by friction fit relative to the interior diameter of the cylindrical vessel while providing a seal between the lid and the vessel in a closed position of the lid. The lid 24 is enclosed at the top side thereof by an upper panel 32 spanning across the top of the lower portion 26 to be continuous with the rim 28. The lid incorporates a layer of heat insulating material therein to insulate the upper boundary of the vessel 14 when the lid is closed and mounted onto the housing. The lid is readily removable simply by lifting upwardly off of the open top end of the housing.

The operating components within the lower chamber 22 of the main housing include a motor 34 for operative connection with a mixing member 36 supported within the vessel 14 at the top end thereof. A shaft 38 is formed integrally as part of the bottom wall 20 of the main housing to extend upwardly from the bottom of the vessel so as to remain fixed and immovable relative to the housing, while supporting the mixing member or agitator 36 rotatably thereon. The shaft 38 joins the bottom wall as a unitary body so as to prevent penetration of liquid through the bottom wall of the housing. The motor 34 within the lower chamber 22 of the main housing generates a rotating magnetic field which interacts with an element within the mixing member 36 that responds to the magnetic field so as to electromagnetically induce rotation of the mixing member relative to the vessel.

The mixing member includes a central body 42 forming a socket in the bottom end thereof that receives the top end of the shaft 38 therein so that the mixing member rotates on the shaft 38, while enabling the mixing member to be detached and removed from the shaft for cleaning and replacement as required. A handle member 44 extends upwardly from the central body for gripping in the hand of a user to assist in removal and re-attachment of the mixing member to the shaft. The mixing member further includes a whisking member 46 attached to the central body of the mixing member in the form of a plurality of circular windings in a spiral pattern collectively forming a coil in the shape of a torus surrounding the central body 42 to be coaxial with the shaft upon which the mixing member is supported. When rotated by the motor 34, the mixing member is arranged for frothing the liquid within the vessel 14.

The mixing member 36 may be interchanged with an auxiliary member 48 having a similar central body 42 with a socket therein for attachment to the shaft and a handle 44 to assist in attaching and removing the auxiliary member 48 from the vessel. In place of a whisking member, the mixing member in this instance may comprise a plurality of radially extending paddles 50 which function to mix the liquid and powder within the vessel with less frothing than the whisking member 46.

The mixing device 10 further includes a controller 52 supported within the lower chamber in the form of a printed circuit board that controls delivery of power to the motor for actuating the motor 34. The controller 52 is connected to a timer 54 which defines a prescribed duration which may be programmed in the range of 1 to 2 minutes for example and more preferably a duration of 90 seconds according to the preferred embodiment.

A common actuator button 56 is supported on the cylindrical wall 18 of the main housing in alignment with the lower chamber 22 such that the actuator button is externally accessible on the main housing. The actuator button is operatively connected to the controller 52 such that manually depressing the actuator button generates an actuation signal for the controller.

A heater is provided in the form of a heating element 58 mounted within the bottom wall 28 of the cylindrical vessel so as to be in heat transferring relationship with the contents of the vessel. The heater is operatively connected to the controller to be supplied with electrical power by the controller as dictated by programming of the controller.

The base 16 of the mixing device includes a platform 60 arranged to be supported on a horizontal supporting surface that further includes an upper supporting surface thereon upon which the bottom of the main housing can be seated in a working position. A protruding lug 62 extends upwardly from a central location on the platform 60 to form a mating connection with a socket 64 formed at the bottom end of the main housing so that the socket 64 receives the protruding lug 62 therein when the main housing is seated on the platform 60 of the base.

A set of three terminals 66 are mounted on the protruding lug 62 of the base and are electrically connected within the platform 60 to a power cord 68 extending from the base to a plug 70 at the distal end of the power cord that is suitably arranged for plugging into a conventional electrical wall socket. In this manner, electrical power is supplied through the power cord 68 to the terminals 66 on the base. A corresponding set of terminals 72 are supported on the bottom of the main housing within the socket 64 for alignment with and connection to the terminals 66 on the base when the main housing is seated on the base. The terminals 72 at the bottom of the main housing are in turn connected to the controller 52 within the lower portion of the main housing for delivering electrical power to the controller.

The controller includes suitable programming such that when an operator depresses the actuator button 56 a single time, a single actuation signal is generated and delivered to the controller, the controller will respond by simultaneously delivering electrical power to the heating element 58 and to the motor 34 of the mixing member 36 to simultaneously mix the liquid and the tea powder within the vessel 14 to produce a tea mixture, while also frothing and heating the tea mixture for a prescribed duration of approximately 90 seconds as defined by the timer 54.

According to the preferred embodiment, a prescribed amount of liquid, for example water or milk, is added to the vessel to partly fill the vessel with between 100 and 250 mL of the liquid, followed by adding a prescribed amount of matcha tea powder in the range of 1 to 20 grams, but most commonly in the range of 1 to 2 grams when preparing a traditional tea beverage. In this instance, mixing and heating the tea mixture for approximately 90 seconds results in a beverage having a serving temperature of approximately 65° C.

The controller may further include programming that responds to an operator depressing the actuator button twice in quick succession, that is within approximately one second of one another for example. In this instance, two distinct actuation signals are delivered to the controller and the controller will instead respond by delivering electrical power only to the motor 34 of the mixing member 36, but not the heating element 58. In this instance the mixing member will be similarly activated for a timed duration of approximately 90 seconds to again suitably mix the tea powder and the liquid while also suitably frothing the tea mixture, but without heating the mixture. When starting with a cold liquid, the resulting prepared beverage will be a cold beverage.

Once mixing and/or heating of the matcha tea beverage is complete, the controller will disconnect power to the motor and the heating element. The user can then detach the main housing from the base, remove the lid, and pour the prepared beverage into a serving cup for consumption by the user.

Since various modifications can be made in the invention as herein above described, and many apparently widely different embodiments of same made, it is intended that all matter contained in the accompanying specification shall be interpreted as illustrative only and not in a limiting sense.

1. A method of making a tea beverage using a tea powder, the method comprising:
providing a mixing device including a vessel for containing a liquid therein, a mixing member supported within the vessel for rotation relative to the vessel, and a heating element operatively connected to the vessel so as to be arranged to heat contents of the vessel;
partly filling the vessel of the mixing device with a selected liquid;
adding a prescribed amount of the tea powder to the selected liquid in the vessel;
actuating the mixing member and the heating element of the mixing device so as to simultaneously (i) mix the selected liquid and the tea powder to form a mixture and (ii) heat the mixture.

2. The method according to claim 1 further comprising partly filling the vessel of the mixing device with between 100 and 250 millilitres of the selected liquid.

3. The method according to claim 1 wherein the prescribed amount of tea powder is in the range of 1 to 20 grams.

4. The method according to claim 3 wherein the prescribed amount of tea powder is in the range of 1 to 2 grams.

5. The method according to claim 1 further comprising mixing and heating the mixture for a duration in the range of 1 to 2 minutes.

6. The method according to claim 1 further comprising mixing and heating the mixture for approximately 90 seconds.

7. The method according to claim 1 further comprising heating the mixture to a temperature exceeding 60 degrees Celsius while mixing the mixture.

8. The method according to claim 1 further comprising heating the mixture to a temperature of approximately 65 degrees Celsius while mixing the mixture.

9. The method according to claim 1 further comprising dispensing the mixture from the mixing device to a serving cup subsequent to heating and mixing the mixture.

10. The method according to claim 1 wherein the mixing member comprises an agitator, the method further comprising frothing the mixture using the agitator.

11. The method according to claim 1 wherein the agitator comprises a plurality of windings of elongated strand material forming a coil.

12. The method according to claim 1 further comprising providing a common actuator button on the mixing device and simultaneously actuating the mixing of the mixture with the mixing member and the heating of the mixture with the heating element using the common actuator button.

13. The method according to claim 1 further comprising providing a timer on the mixing device and actuating the mixing member and the heating element for prescribed duration determined by the timer.

14. The method according to claim 1 further comprising providing a common actuator button on the mixing device and actuating the mixing of the mixture with the mixing member but not the heating of the mixture with the heating element in response to the common actuator button being depressed twice in succession within a prescribed duration.
